(19) United States
(12) Patent Application Publication
(10) Pub. No.: US 2009/0021858 A1
(43) Pub. Date: Jan. 22, 2009

(54) Hard Disk Drive Protection System Based on Adaptive Thresholding

(76) Inventors: Guoyi Fu, Toronto (CA); Troy William Moure, Falun (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/778,915

(22) Filed: Jul. 17, 2007

(51) Int. Cl. G11B 5/016

(52) U.S. Cl. 360/99.01

(57) ABSTRACT

A method and apparatus for detecting unusual motions of an electronic device is disclosed. One example method includes measuring motion values of a device and comparing at least one motion value to a threshold to detect an unusual motion. The threshold is regularly adjusted based on at least a portion of the motion values. Another example method is directed to detecting an unusual motion of an electronic device based on motion values measured over a period of time. A plurality of motion values may be measured over a period of time and a cumulative function of the values may be compared to a threshold. A variety of protective actions or measures may be taken to protect a hard disk drive and/or other components in the electronic device from damage when unusual motions are detected.

### BACKGROUND

1. The Field of the Invention

The present invention relates to hard disk drive protection. More specifically, the present invention relates to methods and systems for adaptively detecting and preventing against hard disk drive damage from dangerous conditions such as drops.

2. The Relevant Technology

Hard disk drives (HDD) are frequently used in portable electronic devices such as mobile phone, laptops, music players, and more. However, HDDs are vulnerable to damage if subjected to excessive force. Because small portable devices are more likely to be dropped and subject to other unusual movements than, for example, a full-sized personal computer, it is important to protect these HDDs against damage. The impact of a drop can severely damage or destroy the HDD.

One way to increase an HDD's tolerance of high accelerations from an impact is to add physical protection. If foam bumpers are used, they can absorb some of the physical shock of impact.

Another way to increase an HDD's acceleration tolerance is to make use of a “park” condition provided by many HDD models. FIG. 1 depicts one example of a typical HDD 100. A typical park condition causes read/write heads 102 to physically move off of and away from the drive surface 104 and into a safe position. HDD 100 can withstand substantially higher accelerations if it is parked prior to an impact.

An inertial sensor (e.g., accelerometer) may detect motion such as a free fall and may signal read/write heads 102 to park safely. However, HDD 100 cannot implement a park command instantaneously. A certain amount of lead time is required. Therefore, an improved HDD should reliably detect drops and other dangerous motions with as much lead time as possible.

Furthermore, portable electronic devices are subject to complex motion during use, e.g., dancing, running, walking, hand over motions, vehicle motion, etc. Free fall typically means that an object is in descending motion due to gravity only. Even though the cause for a free all may be trivial, a free fall process in the real world is seldom a true free fall (i.e., due to gravity force only) and often may involve complex motions. Therefore, it is difficult to detect whether an object is in true free fall as opposed to a typical use, such as running, where low-g periods are long enough to closely resemble free-fall, or dancing, where high-g periods can be misinterpreted as impacts.

Methods and apparatuses for timely, reliable detection of complex motions are, therefore, desirable. Such methods and apparatuses may distinguish between typical use motion and a genuinely dangerous motion, so as not to trigger a false positive. On the other hand, too many false positives while a user is, for example, merely adjusting position, may cause the user to grow tired of the HDD protection feature.

### BRIEF SUMMARY

In general, embodiments of the invention are concerned with systems and methods for promptly detecting various kinds of unusual motions of an electronic device. While disclosed embodiments are described as having particular applicability as HDD protection systems and methods, it will be appreciated that many of the concepts would have equal applicability in the protection of other components of an electronic device as well. Disclosed embodiments may accurately detect a wide range of unusual motions with minimal false positive detections and false negatives.

One example embodiment is directed to a method of detecting an unusual motion of an electronic device using adaptively changing detection thresholds. The method includes measuring one or more motion values of a device. The motion values may include, for example, acceleration values measured by an accelerometer or a function of the acceleration values, e.g., a Euclidean norm. At least one motion value is compared to the adjusted threshold to detect whether an unusual motion is occurring. The threshold is regularly adjusted based on the measured motion values to adapt to different motion conditions that the device may be subject to.

Another example embodiment is directed to a method of detecting an unusual motion of an electronic device based on motion values measured over a period of time. In this method, a plurality of motion values may be measured over a period of time and at least a portion of the values may be compared to a threshold. This method can be suited to detecting particular kinds of unusual motions more quickly than the first method. A variety of protective actions or measures may be taken to protect the electronic device from damage based upon unusual motions detected by either method. In addition, other example embodiments are directed to electronic devices that include various components configured to implement the detection methods and to carry out protective actions.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a typical hard drive disk (HDD) with read/write heads for use in an electronic device;

FIG. 2 illustrates a block diagram of one example of a motion detection system for protecting an electronic device from damage, in accordance with the present invention;

FIG. 3 illustrates an exemplary graph of data on various data lines shown in FIG. 2, in accordance with an embodiment of the present invention;

FIGS. 4A-4C illustrate sample graphs of data on various data lines shown in FIG. 2, in accordance with another embodiment of the present invention;

FIG. 5 illustrates a state diagram of a state transition decider block in FIG. 2; and

FIG. 6 illustrates a flow diagram describing an example of a method for detecting unusual motions of an electronic device.

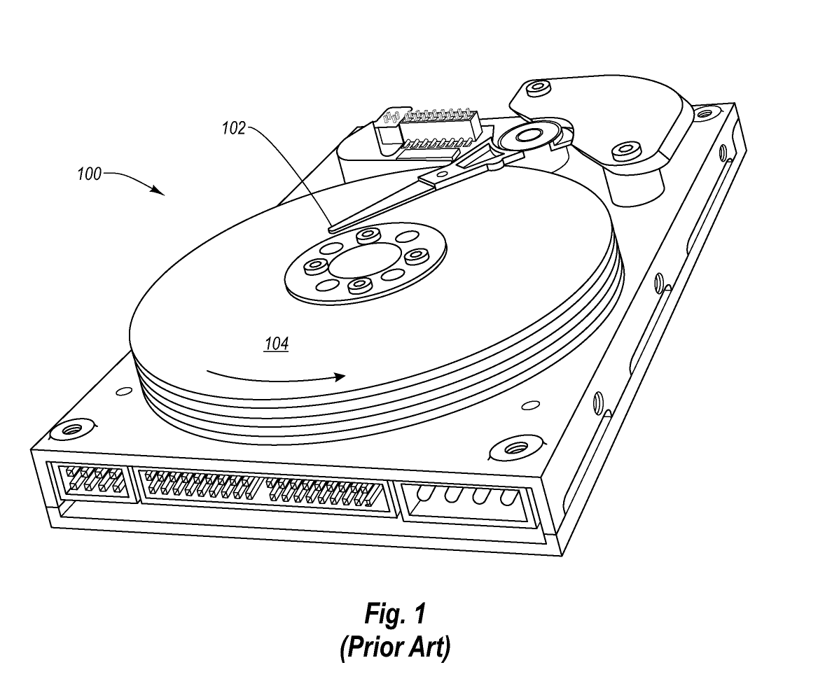

### DETAILED DESCRIPTION

In the following detailed description of various embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The following description provides an example embodiment of a method and apparatus for detection of unusual motions of an electronic device having an HDD. The illustrated example uses an accelerometer to determine a state of the device. The state of the exemplary device may be, for example, stable, monitoring, alert, urgent alert, or impact, depending on the detected acceleration values. The device's state may transition to alert, urgent alert, or impact if, for example, an unusual motion such as a drop or extreme vibration is detected. In an illustrated example, the detection of unusual motions may be accomplished with one or more detection algorithms. For example, an adaptive threshold algorithm may detect a broad range of unusual motions that pose a danger to an HDD in the device. Furthermore, due to the relative complexity of detecting a spinning free fall motion (i.e., when the device is both spinning and in free fall), a second algorithm dedicated to detecting spinning free fall motions may also be implemented. The operation parameters of the algorithms may be adjusted a priori as well as dynamically in accordance with various criteria including, for example, sensitivity to unusual motion, degree of expected extreme motion, tolerability of false negative/positives, and processing power of the device.

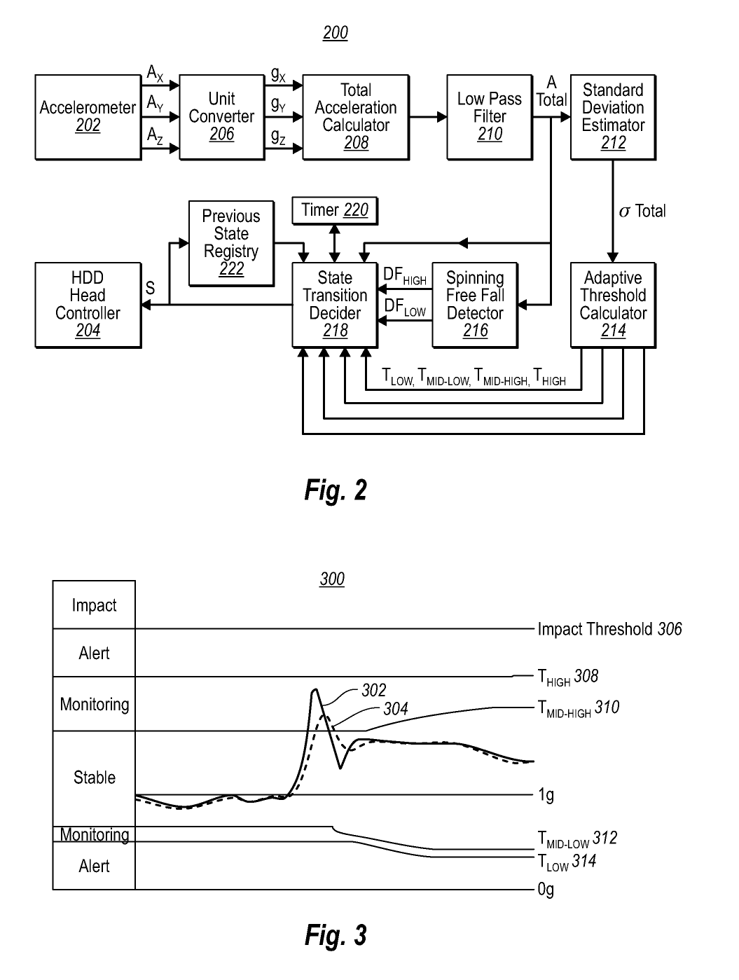

FIG. 2 shows a block diagram of a motion detection system 200 implemented in an electronic device in accordance with an example embodiment of the invention. Detection system 200 can be implemented using hardware, software, firmware, or any combination thereof. For example, detection system 200 may include one or more circuits, such as dedicated processors, to carry out one or more functions of the various functional blocks shown. As used herein, the term circuit may also include other components such as digital processors, analog processors, programmable logic arrays and devices, programmable array logic, field programmable gate/logic arrays, electrically erasable/programmable read only memory, microcontrollers, application specific circuits, etc. In certain embodiments consistent with the invention, the functions of the various functional blocks may also be implemented as one or more threads on a central circuit or processor of the electronic device.

As shown in FIG. 2, detection system 200 may include an accelerometer 202 to detect the electronic device's motion and an HDD read/write head controller 204 to output a control signal to HDD read/write heads 102. Detection system 200 may also comprise the following functional blocks between accelerometer 202 and controller 204: a unit converter 206, a total acceleration calculator 208, a low pass filter 210, a standard deviation estimator 212, an adaptive threshold calculator 214, a spinning free fall detector 216, a state transition decider 218, a timer 220, and a previous state registry 222.

Unit converter 206 may receive as input a plurality of motion values from accelerometer 202. The motion values may be measurements of acceleration in three directions (denoted as Aₓ, A_{y}, and A_{z} in FIG. 2). The motion values, Aₓ, A_{y}, and A_{z} from accelerometer 202, may not be scaled appropriately for meaningful evaluation. Therefore, unit converter 206 may convert Aₓ, A_{y}, and A_{z} to units of g (i.e., 1 g=9.8 m/s²) according to the following exemplary formulas:

gₓ=(Aₓ−ZeroOffsetₓ)*ScalingFactor

g_{y}=(A_{y}−ZeroOffset_{y})*ScalingFactor

g_{z}=(A_{z}−ZeroOffset_{z})*ScalingFactor

Moreover, in certain embodiments unit converter 206 may be integral with either accelerometer 202 and/or acceleration calculator 208.

Acceleration calculator 208 may receive the outputs of unit converter 206, converted motion values gₓ, g_{y}, and g_{z}, and may output a total acceleration measurement. The total acceleration measurement may be a function of the converted motion values. For example, acceleration calculator 208 may calculate a Euclidean norm of the converted motion values, according to the formula:

Total Acceleration=\sqrt{gₓ²+g_{y}²+g_{z}²}

Low pass filter 210 may receive as input the total acceleration measurement from acceleration calculator 208 and may output a filtered total acceleration measurement (denoted Aₜₒₜₐₗ) The total acceleration measurements, Aₜₒₜₐₗ, may be received by multiple functional blocks in FIG. 2. Depending on design constraints, such as cost and complexity, low pass filter 210 may not be implemented in detection system 200 and the unfiltered total acceleration measurement output by acceleration calculator 208 may instead be used. However, when implemented, low pass filter 210 may improve detection reliability. Low pass filter 210 may be implemented as a single pole recursive low-pass filter. The single pole recursive digital filter may mimic an analog resistor-capacitor filter with two coefficients.

y[n]=a₀x[n]+b₁y[n−1]

where x and y correspond to the input and output, respectively, of low pass filter 210. The coefficients, aₒ and b₁, correspond to recursion coefficients. In exemplary embodiments, a sampling rate of low pass filter 210 may be 200 Hz, in which case the recursion coefficients may be set to, for example, aₒ=0.15 and b₁=0.85.

In a first motion detection algorithm, state transition decider 218 may receive and compare current acceleration measurements (Aₜₒₜₐₗ) with adaptive thresholds (T_{low}, T_{mid-low}, T_{mid-high}, and T_{high} in FIG. 2). The adaptive thresholds are set by adaptive threshold calculator 214 based on past acceleration measurements. For example, the adaptive thresholds may change based on an output of standard deviation estimator 212, which receives acceleration measurements over a period of time and estimates a standard deviation of the total acceleration (denoted total in FIG. 2). The estimation of total may be accomplished in various ways. For example, assuming a normal distribution of measurements, a sample standard deviation formula may be applied to a sample of total acceleration measurements (Aₜₒₜₐₗ).

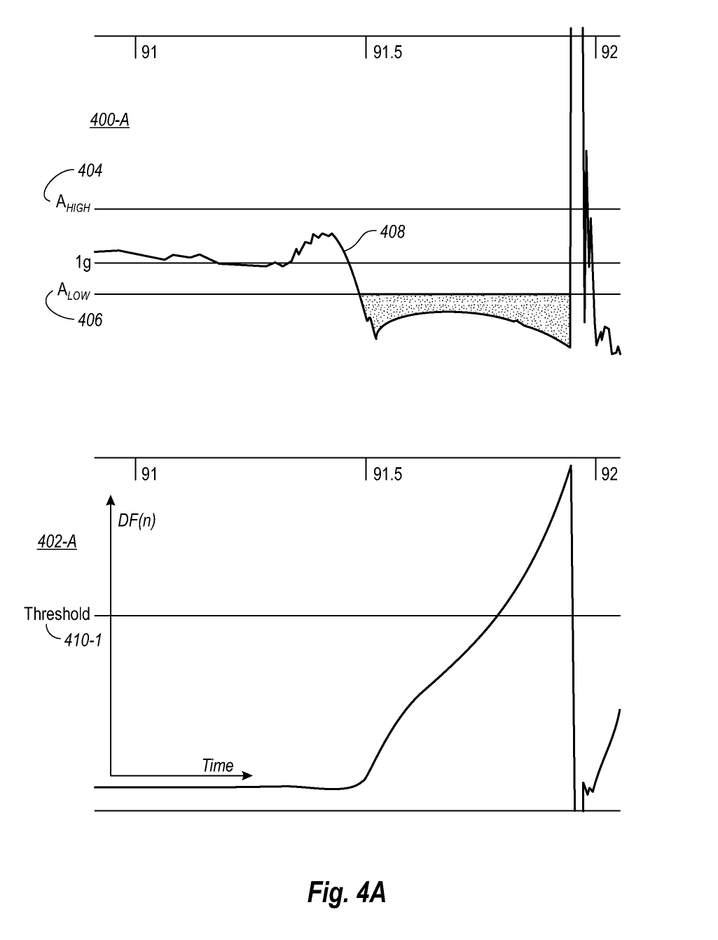

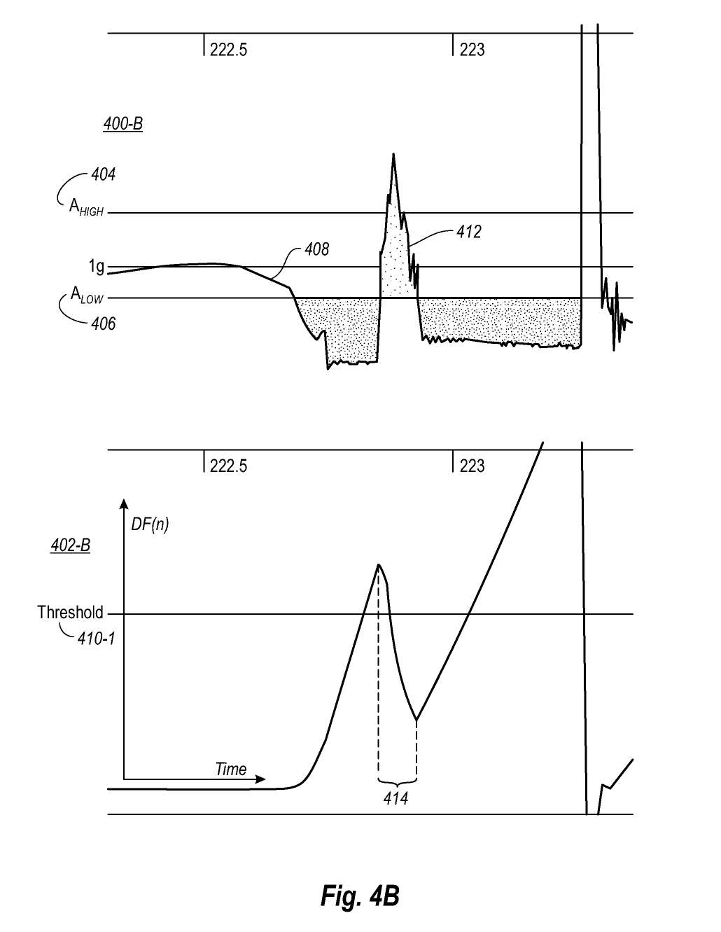

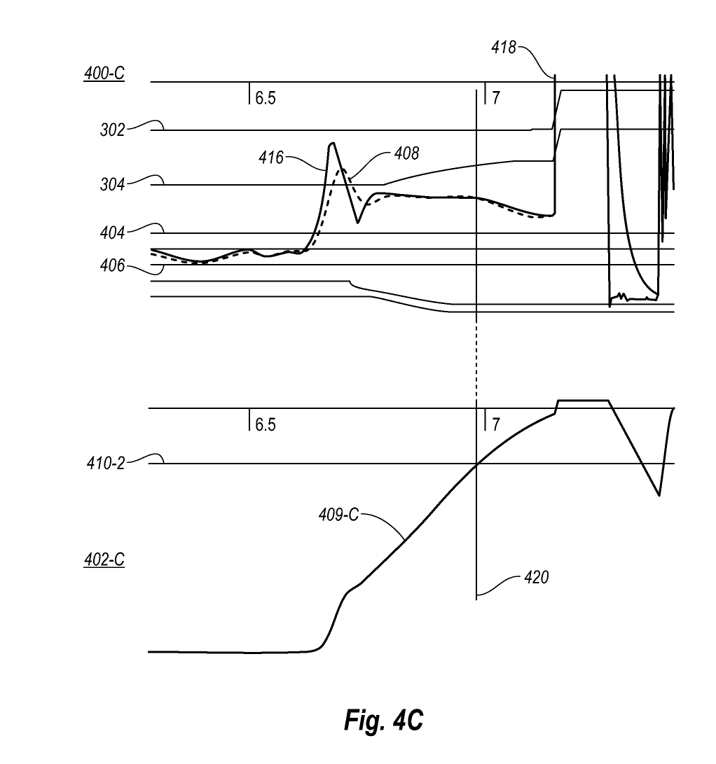

In a second motion detection algorithm, state transition decider 218 may compare cumulative functions of motion values generated by spinning free fall detector 216 with thresholds to detect a spinning free fall motion. These motion detection algorithms are explained in greater detail below in connection with FIGS. 3 and 4, respectively.

As explained above, state transition decider 218 may receive inputs from spinning free-fall detector 216 and adaptive threshold calculator 214. In addition, state transition decider 218 may send output to and receive input from timer 220 and from previous state registry 222. A decision to transition to a new state may depend on: threshold comparisons, a time lapse reported by timer 220, and a previous state as reported by previous state registry 222.

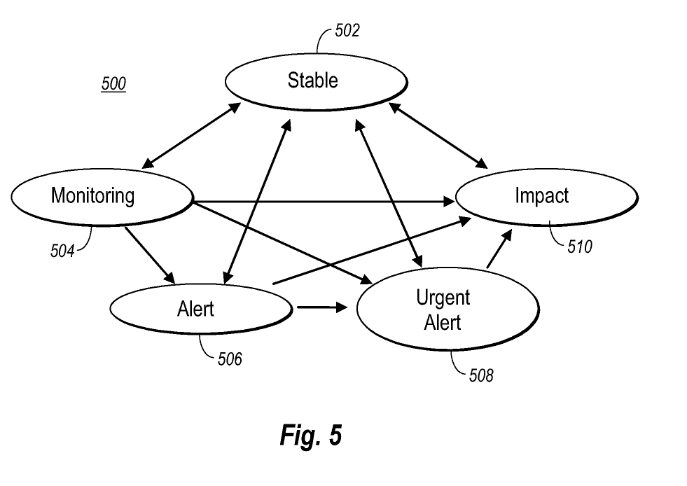

HDD read/write head controller 204 may read or receive as input a current state from state transition decider 218 to determine whether to park HDD read/write heads 102 and what type of park command to implement. For example, HDD head controller 204 may issue a standard parking command when a current state is “Alert” or “Impact.” In addition, HDD head controller 204 may issue an emergency parking command, which responds more quickly, when a current state is “Urgent Alert.” Various exemplary states and conditions for state transitions are explained in greater detail below in connection with FIG. 5.

FIG. 3 illustrates a sample graph 300 associated with a first algorithm for detecting unusual motions. Generally, according to the first algorithm, an unusual motion may be predicted or detected by comparing total acceleration measurements 302 and 304 with adaptive thresholds 308, 310, 312, and 314. In graph 300 total acceleration measurements 302 are unfiltered and total acceleration measurements 304 are filtered. In addition, an impact threshold 306 may be a maximum possible measurement output by the particular accelerometer 202 used (e.g., 3 g for a 3 g accelerometer). The adaptive thresholds 308, 310, 312, and 314 may be determined dynamically according to the following equations:

T_{low}=1.0−2.2σₜₒₜₐₗ

T_{mid-low}=1.0−1.9σₜₒₜₐₗ

T_{mid-high}=1.0+2.8σₜₒₜₐₗ

T_{high}=1.0+3.8σₜₒₜₐₗ
where σₜₒₜₐₗ is the output of standard deviation estimator 212 in FIG. 2.

The adaptive threshold formulas above may vary according to different embodiments and combinations consistent with the invention. For example, the σₜₒₜₐₗ coefficients (e.g., −2.2, −1.9, +2.8, +3.8) may be set to different values in accordance with user preferences or manufacturing design preferences. In addition, the relationship between the adaptive thresholds and σₜₒₜₐₗ need not necessarily be linear. Maximum and minimum limits may be imposed on the amount each threshold may vary and the number of thresholds may also vary. For example, additional thresholds and states may be recognized. In certain other embodiments, T_{mid-high} 310, T_{mid-low} 312, and the monitoring state may be eliminated.

As shown in FIG. 3, acceleration measurements 302 and 304 are centered around 1 g during a stable state of the electronic device due to the steady force of gravity. The monitoring state is entered when acceleration measurements 304 either cross threshold T_{mid-high} 310 or cross threshold T_{mid-low} 312 (a brief crossing of threshold T_{mid-high} 310 is shown in the figure). When extreme high or low acceleration measurements or extreme changes of acceleration measurements in a short period occur, the thresholds adaptively expand by virtue of an increased σₜₒₜₐₗ, as shown in graph 300. This adaptive feature serves to reduce the number of false positives when the associated device is being used in an active way. Moreover, when the device is subsequently used in a passive way, e.g., continuously held in a stable position, total decreases, the thresholds become tighter, and the number of false negatives is reduced.

FIGS. 4A-C illustrate various sample graphs, which serve to demonstrate how a second detection algorithm may promptly detect a spinning free fall. Generally, the second algorithm may predict unusual motions based not only on total acceleration measurements but also based on how long the total acceleration measurements stay at extreme levels. Thus, a cumulative function of total acceleration measurements is compared to a threshold rather than only current total acceleration measurements. According to theories underlying the second algorithm, sufficiently long intervals of deviation from average acceleration levels may indicate changes in the state of the associated device (e.g., changes from stable to a low-g state or a high-g state). By virtue of this different approach, the second algorithm predicts some spinning free fall and/or some complex drops where the first algorithm discussed above may fail to predict such motions/drops due to the presence of a force, such as centrifugal force, during the complex motion.

FIG. 4A depicts a top graph 400-A and a bottom graph 402-A relevant to the spinning free fall detection algorithm. In top graph 400, two acceleration levels A_{low} 404 and A_{high} 406 are shown, which may be specified as algorithm parameters. For each of these levels, the second algorithm may calculate Detection Functions (DF) by integrating a difference between total acceleration measurements 408 and the respective levels. The integrated or accumulated area between the total acceleration measurements 408 and A_{low} 404 at time n may be denoted DF_{low}(n) and the accumulated area between the total acceleration measurements 408 and A_{high} 406 at time n may be denoted DF_{high}(n). An exemplary DF_{low}(n) plot 409-A is depicted in bottom graph 402-A. DF_{low}(n) and DF_{high}(n) may be computed by the following recurrence equations:

DF_{low}(n)=min(L_{df},max(0,DF_{low}(n−1)+2×(A_{low}−aₜₒₜₐₗ(n))))

DF_{high}(n)=min(L_{df},max(0,DF_{high}(n−1)+(aₜₒₜₐₗ(n)−A_{high})))

where aₜₒₜₐₗ(n) corresponds to a total acceleration measurement at time n. The DF_{low}(n) and DF_{high}(n) plots may be restricted to being less than a set limit value L_{df} to ensure that extreme acceleration events will not have unrealistic long-lasting effects on the model.

If DF_{low}(n) exceeds a preset threshold 410-1 (T_{DF-low}) in graph 402-A an alert state may be triggered. Similarly, an alert state may be triggered if DF_{high}(n) (which is not shown) exceeds a preset threshold. For example, in graph 402-A, DF_{low}(n) plot 409-A is shown crossing threshold 410-1, which may cause HDD head controller 204 to park HDD heads 102 and thereby prevent damage from a spinning free fall impact.

Algorithm parameters A_{low} 404 and A_{high} 406 may normally be predetermined values. In certain other embodiments consistent with the invention, A_{low} 404 and A_{high} 406 may be determined adaptively like the adaptive thresholds generated by adaptive threshold calculator 214 (T_{low}, T_{mid-low}, T_{mid-high}, and T_{high} in FIG. 2).

FIG. 4B demonstrates certain aspects of the second algorithm for detecting a spinning free fall. FIG. 4B depicts a top graph 400-B and a bottom graph 402-B. Graph 400-B shows that if the acceleration of the device is less than A_{low} 404 or greater than A_{high} 406, the accumulated area under total acceleration measurements plot 408 is considered positive in determining DF_{low}(n) plot 409-B, otherwise the area is considered negative. For example, shaded area 412 is considered negative and DF_{low}(n) plot 409-B in graph 402-B reflects this at graph segment 414. This aspect of the second algorithm guards against excessive false positive detections of a spinning drop.

FIG. 4C demonstrates certain additional aspects of the second algorithm for detecting a spinning free fall. A top graph 400-C shows an exemplary total acceleration measurements plot 408. An unfiltered version (i.e., not filtered by low pass filter 210) of total acceleration measurements plot 408 is also depicted as plot 416. As shown in plots 408 and 416, an impact occurs at time 418. However, thresholds 302 and 304 are not triggered by total acceleration measurement plot 408 until very close to impact time 418, which does not allow sufficient time to protect HDD 100 against damage. Thus, the first motion detection algorithm is inadequate for detecting the dangerous motion depicted in graph 400-C. Graph 402-C demonstrates that the second algorithm for detecting a spinning free fall makes up for the inadequacy of the first algorithm because it detects the dangerous motion at an earlier time 420 (i.e., when threshold 410-2 is triggered by DF_{high}(n) plot 409-C). The earlier detection allows a brief period of time for HDD head controller 204 to prepare HDD 100 for an impact.

FIG. 5 shows a state transition diagram 500, which may be implemented by state transition decider 218 or other associated processor(s). Possible states may include the following: a stable state 502, a monitoring state 504, an alert state 506, an urgent alert state 508, and an impact state 510. State transition decider 218 may transition from one state to another based on the various thresholds shown in FIGS. 3 and 4A-C and other criteria as outlined in Table 1 below.

TABLE 1
State Transition Conditions

| From State | To State | Condition |
|---|---|---|
| Stable | Monitoring | Total acceleration is outside the monitoring threshold |
| | | (greater than T_{mid-high} 310 or less than T_{mid-low} 312) |
| Stable or | Alert | Total acceleration is outside the alert thresholds (greater than |
| Monitoring | | T_{high} 308 or less than T_{low} 314), but has not exceeded impact |
| | | threshold 306 |
| | | OR |
| | | DF(n) 409 triggers threshold 410 (either DF_{low}(n) is above |
| | | T_{DF-low} or DF_{high}(n) is above T_{DF-high}) |
| Stable or | Urgent | Total acceleration is outside the monitoring threshold |
| Monitoring | Alert | AND |
| or Alert | | DF_{low}(n) is above T_{DF-low} OR DF_{high}(n) is above T_{DF-high}. |
| Any Except | Impact | Total acceleration exceeds the impact threshold. |
| Impact | | |
| Monitoring | Stable | The total acceleration has continuously been inside the |
| | | monitoring thresholds for the last x seconds. |
| Alert or | Stable | The total acceleration has continuously been inside the |
| Urgent | | monitoring thresholds for the last y seconds. |
| Alert | | |
| Impact | Stable | The total acceleration has continuously been inside the |
| | | monitoring thresholds for the last z seconds. |

State transition decider 218 may evaluate the conditions listed above in determining whether to make a state transition. The last three conditions listed above require measurement of a time lapse. For example, returning to stable state 502 from monitoring state 504 may be conditioned upon total acceleration measurements 304 remaining within the monitoring thresholds for x seconds, where a typical value for x may be around 0.5 seconds. In addition, returning to stable state 502 from alert state 506 or urgent alert state 508 may require a longer lapse of time (y seconds), such as 0.75 seconds. Returning to stable state 502 from impact state 510 may require an even longer lapse of time (z seconds), such as one second. In this manner, an interruption in use of HDD 100 may be greater for relatively dangerous motions but minimal for relatively less dangerous motions. Alternatively, the waiting time periods (x, y, and z seconds) may all be set to the same value (e.g., 0.5 seconds).

HDD head controller 204 may control HDD read/write heads 102 in different ways depending on a current state decided by state transition decider 218. For example, in stable and monitoring states 502 and 504, respectively, HDD head controller 204 may do nothing, i.e., permit HDD 100 to operate normally. In alert state 506, HDD head controller 204 may issue a standard parking command, whereas an emergency parking command may be issued in urgent alert state 508 or impact state 510. Furthermore, implementation of the second algorithm for predicting a spinning free fall motion may be activated/de-activated depending on a current state. For example, spinning free fall detector 216 of FIG. 2 may receive an input indicating a current state. Based on this input, spinning free fall detector 216 may be activated when a current state changes to monitoring. When activated, spinning free fall detector 216 may begin calculating DF_{low}(n) and DF_{high}(n). When the state of the device returns to stable, spinning free fall detector 216 may be de-activated and may stop calculating DF_{low}(n) and DF_{high}(n), thereby preserving resources such as power and processing time.

A standard parking command may take a longer time to implement than an emergency parking command. In certain HDDs, an emergency parking command can typically park HDD read/write heads 102 within 140 milliseconds. However, if a write is in progress it will be aborted and the data being written may be lost. Also, emergency parking commands may typically be guaranteed to work only a limited number of times over the lifetime of the HDD. After that, damage may result. A standard parking command, on the other hand, may be used in a virtually unlimited fashion but may also take longer. A longer delay may occur, for example, because a standard parking command will wait for HDD read/write heads 102 to finish any write operation in progress before parking. Therefore a standard parking command may typically take 350 to 500 milliseconds or even up to one second depending on the circumstances. In some cases where an emergency parking command is not available or the potential risk of false positives is too great (due to the impact on the HDD's life expectancy), only the standard parking command may be used for the alert, urgent alert, and impact states.

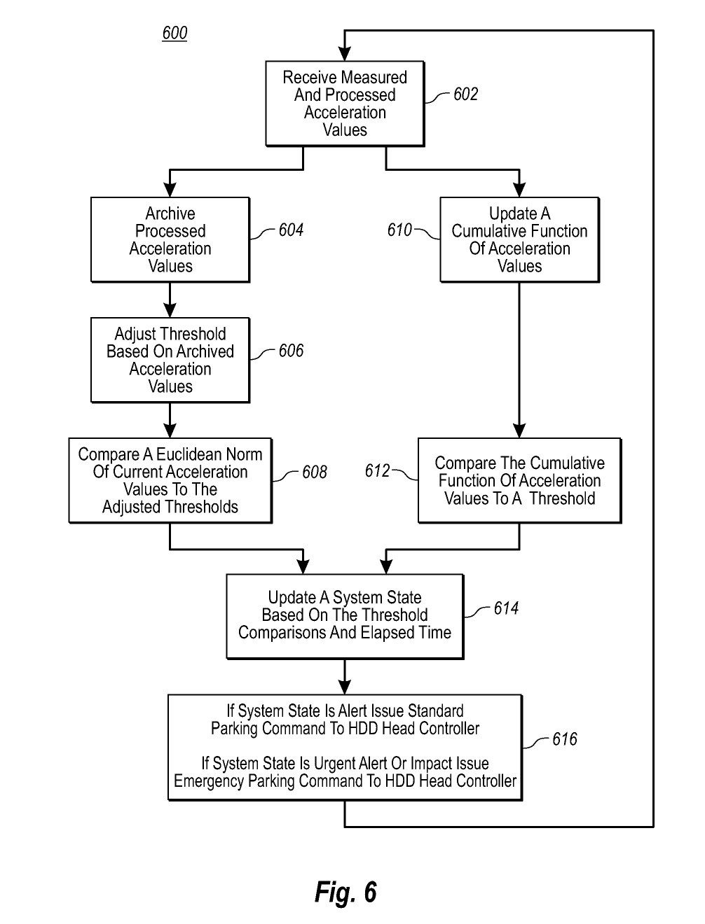

FIG. 6 shows a method 600 in a flowchart form for detecting unusual motions of a device and taking protective measures to protect an HDD in the device. Method 600 may be implemented in hardware or executed as software/firmware by one or more processors or circuits associated with motion detection system 200. First, motion detection system 200 may receive measured acceleration values of the device from a sensor (stage 602). The acceleration values may also be processed, e.g., by filtering and/or unit conversion.

Next, received values may be analyzed to detect dangerous or unusual motions of the associated device (stages 604-612). For example, a first algorithm may archive the processed acceleration values (stage 604), adjust thresholds based on archived acceleration values (stage 606), and compare a Euclidean norm of currently received acceleration values to the adjusted thresholds (stage 608) to detect an unusual motion. The archived values used to derive or adjust the thresholds may include, for instance, one second or more of historical data. As time lapses, the thresholds may be updated in a regular fashion based on newly measured acceleration values.

A second algorithm may concurrently analyze data to detect unusual motions by first updating a cumulative function of acceleration values with the received acceleration values (stage 610). Then, the second algorithm may proceed to compare the cumulative function of acceleration values to a threshold (stage 612) to detect a particular type of unusual motion such as a spinning free fall motion. This comparison threshold may be predetermined, configurable by a user, or adaptively adjusted similar to the adaptive thresholds in the first algorithm.

Based on the threshold comparisons of each algorithm, motion detection system 200 may update a system state (stage 614). Under some circumstances, updating the system state may also depend on an elapsed time period. For example, an elapsed time may be measured to determine whether it is likely that the device has settled back to a stable condition (i.e., experiencing extreme or unusual motions) from a dangerous condition (i.e., experiencing little or no motion). Finally, if the system state update results in an alert state, a standard parking command may be issued to HDD read/write head controller 204. Also, if the system state update results in an urgent alert state or an impact state, an emergency parking command may be issued to quickly prevent damage to HDD 100 (stage 616).

Stages shown in FIG. 6 may be modified in various ways. For example, the order of stages may be varied, certain stages may be omitted and/or additional stages may be added. The stages may be implemented or may occur at the same frequency or at differing frequencies. For example, comparison stage 608 may occur more frequently or less frequently than adjustment stage 606. Similarly, comparison stage 612 may occur more frequently or less frequently than cumulative function updating stage 610. Moreover, although FIG. 6 shows two unusual motion detection algorithms implemented simultaneously, certain embodiments of the invention may implement only the first algorithm or only the second algorithm, or more than two algorithms. For example, stages 610 and 612 may be omitted in one embodiment or, alternatively, stages 604-608 may be omitted in another embodiment.

Methods and systems described herein may include various configurable settings for implementing motion detection algorithms. Configurable settings may include those listed in Table 2 below.

TABLE 2
Configurable Settings

| Setting | Typical Value(s) |
|---|---|
| waiting periods before returning to stable | 0.5 seconds-1 second |
| state | |
| impact threshold 306 | 2 g-4 g |
| acceleration level A_{low} 404 | 0.8 g |
| acceleration level A_{high} 406 | 1.2 g |
| low DF(n) threshold 410-1 (T_{DF-low}) | 35 (100 Hz sampling rate) |
| | 17.5 (200 Hz sampling rate) |
| high DF(n) threshold 410-2 (T_{DF-high}) | 45 (100 Hz sampling rate) |
| | 22.5 (200 Hz sampling rate) |
| maximum limit on DF(n) | 30 (100 Hz sampling rate) |
| (i.e., L_{df}, maximum low g or high g | 60 (200 Hz sampling rate) |
| accumulation) | |
| minimum limit of T_{mid-low} 312 | 0.3 g |
| maximum limit of T_{mid-low} 312 | 0.6 g |
| minimum limit of T_{mid-high} 310 | 1.8 g |
| maximum limit of T_{mid-high} 310 | 2.5 g |
| minimum limit of T_{low} 314 | 0.2 g |
| maximum limit of T_{low} 314 | 0.4 g |
| minimum limit of T_{high} 308 | 2.5 g |
| maximum limit of T_{high} 308 | 3.0 g |
| recursion coefficient a₀ in low pass filter 210 | 0.25 (100 Hz sampling rate) |
| | 0.15 (200 Hz sampling rate) |
| recursion coefficient b₁ in low pass filter 210 | 0.75 (100 Hz sampling rate) |
| | 0.85 (200 Hz sampling rate) |
| σₜₒₜₐₗ coefficient in T_{mid-low} formula | 1.9 |
| σₜₒₜₐₗ coefficient in T_{mid-high} formula | 2.8 |
| σₜₒₜₐₗ coefficient in T_{low} formula | 2.2 |
| σₜₒₜₐₗ coefficient in T_{high} formula | 3.8 |

One or more configurable settings may be configurable by a user only, a manufacturer only, or by either. Furthermore, certain embodiments may include a configurable protection level, whereby a user may conveniently change a plurality of settings by selecting a desired protection level for their electronic device. For example, a user may select a “normal priority” protection level, an “action priority” protection level, or a “protection priority” protection level.

A “normal priority” user may be one who expects to use the device under normal circumstances with non-extreme movements such as walking, climbing up/down stairs, changing device orientation, standing, sitting, etc. Thus if a “normal priority” protection level is selected, the settings listed in Table 2 above may be set so as to make the device moderately sensitive to a select number of unusual motions.

Similarly, a user who intends to use their device under more extreme conditions, e.g., while running, dancing, etc., may select an “action priority” protection level. Selection of the “action priority” level may alter the configurable settings to allow for a wide range of unusual motions without parking the HDD heads. Thus, under this setting, the HDD heads would be parked only if an extremely unusual motion, such as a drop or excessive shaking/vibrations, is detected. In addition, under this configuration spinning free fall detector 216 may be configured to calculate only DF_{low}(n) and not DF_{high}(n) since extremely low acceleration levels tend to more frequently indicate a spinning free fall.

A “protection priority” user may be the opposite of an “action priority” user. For instance, a user may select this configuration if the user is extremely gentle with their electronic device and only expects large accelerations to be genuine falls. Under this configuration, the device may automatically change settings so as to be more sensitive to a wide range of unusual motions including, for example, walking up/down stairs, roughly placing the device on a table or other surface, quickly picking up the device, abruptly changing device orientation, etc.

Embodiments herein may comprise a special purpose or general-purpose computer including various computer hardware implementations. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for detecting an unusual motion of an electronic device, the method comprising:
measuring motion values of the device; and
comparing at least one motion value to a first threshold to detect the unusual motion;
wherein the first threshold is regularly adjusted based on at least a portion of the motion values.

2. The method as recited in claim 1, wherein the motion values indicate an acceleration of the device in one or more directions.

3. The method as recited in claim 1, wherein measuring the motion values includes measuring acceleration values of the device in a plurality of directions and determining a Euclidean norm of the measured acceleration values.

4. The method as recited in claim 1, wherein the unusual motion includes at least one of a free fall motion, an impact motion, and a vibrating motion.

5. The method as recited in claim 1, further comprising:
taking a protective action if the unusual motion is detected.

6. The method as recited in claim 5, wherein the protective action includes adjusting a position of a hard drive head in the device.

7. The method as recited in claim 1, wherein the first threshold is a high threshold, the method further comprising:
comparing the at least one motion value to a low threshold,
wherein the unusual motion is detected if the at least one motion value is greater than the high threshold or less than the low threshold.

8. The method as recited in claim 1, further comprising:
processing the motion values to filter out noise.

9. A method for detecting an unusual motion of an electronic device, the method comprising:
measuring a plurality of motion values of the device over a period of time; and
comparing at least a portion of the motion values to a first threshold to detect the unusual motion.

10. The method as recited in claim 9, further comprising:
comparing a most current one of the plurality of motion values to a second threshold to detect the unusual motion,
wherein the second threshold is regularly adjusted based on at least a portion of the plurality of motion values.

11. The method as recited in claim 10, further comprising:
taking a first protective action if one of the first and second thresholds is triggered; and
taking a second protective action if both the first and second thresholds are triggered.

12. The method as recited in claim 9, wherein comparing the motion values to the first threshold includes determining a cumulative function of the motion values and comparing the cumulative function of the motion values to the first threshold.

13. An electronic device comprising:
a sensor configured to measure motion values of the device; and
a circuit configured to compare at least one motion value to a first threshold to detect the unusual motion;
wherein the first threshold is regularly adjusted based on at least a portion of the motion values.

14. The device of claim 13, wherein the motion values correspond to acceleration values of the device.

15. The device of claim 13, wherein the unusual motion includes at least one of a free fall motion, an impact motion, and a vibrating motion.

16. The device of claim 13, wherein the circuit is further configured to adjust a position of a hard drive head in the device if the unusual motion is detected.

17. The device of claim 13, wherein the first threshold is a high threshold, the circuit being further configured to compare the at least one motion value to a low threshold,
wherein the unusual motion is detected if the function is greater than the high threshold or less than the low threshold.

18. An electronic device comprising:
a sensor configured to measure a plurality of motion values of the device over a period of time; and
a circuit configured to compare at least a portion of the motion values to a first threshold to detect an unusual motion of the device.

19. The device of claim 18, wherein the circuit is further configured to:
compare a most current one of the plurality of motion values to a second threshold to detect the unusual motion,
wherein the second threshold is regularly adjusted based on at least a portion of the plurality of motion values.

20. The device of claim 19, wherein the circuit is further configured to:
take a first protective action if one of the first and second thresholds is triggered; and
take a second protective action if both the first and second thresholds are triggered.
